(19) United States
(12) Patent Application Publication
(10) Pub. No.: US 2010/0300791 A1
(43) Pub. Date: Dec. 2, 2010

(54) MOTORCYCLE WITH A BLOWER FOR ENGINE COOLING

(75) Inventor: B. T. Kern, Lebanon, TN (US)

Correspondence Address: BRADLEY ARANT BOULT CUMMINGS LLP, 200 CLINTON AVE. WEST, SUITE 900, HUNTSVILLE, AL, 35801, US

(73) Assignee: Nu-Tek Invention, LLC, Lebanon, TN (US)

(21) Appl. No.: 12/473,705

(22) Filed: May 28, 2009

(51) Int. Cl. B62K 11/00

(52) U.S. Cl. 180/229

(57) ABSTRACT

A motorcycle has a frame with a front and rear portion. A steering assembly is connected to the front portion, and a rear wheel is connected to the rear portion. The motorcycle includes a drive train with an air cooled engine and a transmission. The engine has a front end and a rear end, as well as a left side and a right side. The engine sides are substantially exposed, such that the engine is substantially visible when the motorcycle is viewed from the side. The motorcycle also includes a blower with an air discharge directed towards one of the front or rear ends of the engine, where the blower aid in cooling the engine.

### BACKGROUND OF THE INVENTION

a. Field of the Invention

This invention relates to blowers aerodynamically creating air flow used for cooling, and more particularly to blowers used for cooling air cooled engines.

b. Description of the Related Art

Motorcycle engines are typically either air cooled or water cooled. Air cooled engines rely on a flow of air around heat transfer surfaces such as fins to cool the engine. Water cooled engines use a flow of liquid coolant within the engine to exchange heat and cool the engine. A heat exchanger, such as a radiator, is used to transfer heat from the liquid coolant to the air.

The higher the volume of air flowing around an air cooled motorcycle engine, the more effective the cooling fins are at transferring heat from the engine to the air. The fins are less effective when the motorcycle operates at low speeds or when the motorcycle is not moving at all, because there is less air flow moving around the cylinders and the engine. Under these conditions the temperature of the engine can increase substantially. Inadequate cooling can decrease the service life of an engine, and in some cases cause premature engine failure. Certain motorcycles may enter a pre-ignition sequence when overheating, where fuel entering the combustion chamber ignites before the spark plug fires, and a computer limits the fuel flow to the engine to prevent damage. A motorcycle engine running hot may also cause discomfort to a rider due to the proximity of the rider's legs to the engine.

The air flow around a motorcycle engine can be substantially reduced when the engine is operated at very low speeds, which frequently occurs with the engine idling. There are many times when a motorcycle is operated at very low speeds, such as during traffic jams or backups, during parades, when the engine is being worked on or when the engine is idled to keep the engine warm. A motorcycle in heavy, slow traffic may overheat due to the lack of air flow. In some cases the engine will overheat and start the pre-ignition sequence, and the engine may actually shut down. If the engine stops, the rider must manually push the motorcycle from traffic and allow the engine to cool before continuing. It can be hazardous to be trapped on public roads with a non-functioning motorcycle, such as during a traffic jam.

Some motorcycles are used by police officers for their police duties. Often times these police motorcycles will have accessories which tend to drain the motorcycle battery. The accessories can include radios, radar guns, flashing lights and other items. To keep the battery charged and keep these accessories operating, policemen will frequently leave their motorcycle idling while parked. If the police motorcycle uses an air cooled engine, this can result in overheating and the various associated problems. Therefore, eliminating or reducing the overheating issue for air cooled motorcycle engines may enhance safety and law enforcement productivity.

Some motorcycle manufacturers acknowledge the issue with overheating of air cooled engines. For example, some motorcycles associated with the trademark HARLEY DAVIDSON and motorcycles associated with the trademark BUELL include sections in their operating manuals indicating that air cooled engines require air movement over the cylinders and heads to maintain proper operating temperatures. The manuals also indicate extended periods of idling or parade duty can overheat the engine resulting in serious engine damage.

Some motorcycles associated with the trademark HARLEY DAVIDSON which utilize air cooled engines are known to have issues with overheating. There are examples when an air cooled engine operated at low speeds overheats to a point where the engine begins a pre-ignition sequence. If the motorcycle remains in low speed operation, the engine will shut down and must be allowed to cool before the engine can be restarted. To address this issue, Harley-Davidson offers a fan for certain air cooled motorcycle engines which advertises a 20 degree reduction in oil temperature measured at the oil tank. These fans can be mounted on the side of the engine, and there are examples where engines overheat with these fans mounted and operating. These fans are also designed to mount directly to the motorcycle engine, and there are reports of these fans vibrating loose over a period of time.

Besides being a safety hazard, overheating engines on motorcycles also present maintenance issues. The overheating can result in engine damage and can shorten the life of an engine. The high heat can damage and degrade the lubricating oil which is used within the engine, and there are thermal expansion and contraction issues with the materials used within the engine. Operating an engine at lower temperatures as designed can result in a longer service life for the engine. Operating an engine with improved cooling capabilities can enhance performance, safety, and rider comfort on a motorcycle.

### BRIEF SUMMARY OF THE INVENTION

The invention comprises a motorcycle including a frame with a front portion and a rear portion. A steering assembly is connected to the front portion of the frame, and the steering assembly includes a rotatable front wheel. The motorcycle also includes a rear wheel which is rotatable connected to the rear portion of the frame. A drive train is included which includes an air cooled engine connected to a transmission. The drive train is connected to the frame and the drive train engine includes a front end, a rear end, a left side and a right side. The drive train engine powers the transmission and the transmission provides the force to rotate the motorcycle rear wheel. The engine is designed with the engine's sides substantially exposed such that the engine is substantially visible from the side. The motorcycle also includes a blower with an air discharge, and the air discharge is directed towards one of the front end or rear ends of the engine.

### BRIEF DESCRIPTION OF THE SEVERAL VIEWS OF THE DRAWINGS

FIG. 1 is a left side view of an entire motorcycle.

FIG. 2 is a right side view of the engine area of a motorcycle.

FIG. 3 is a front view of a motorcycle engine.

FIG. 4 is a left side view of a motorcycle engine.

FIG. 5 is a top view of the top portion of a motorcycle engine showing air flow from a blower.

### DETAILED DESCRIPTION

### Engine Heating and Cooling

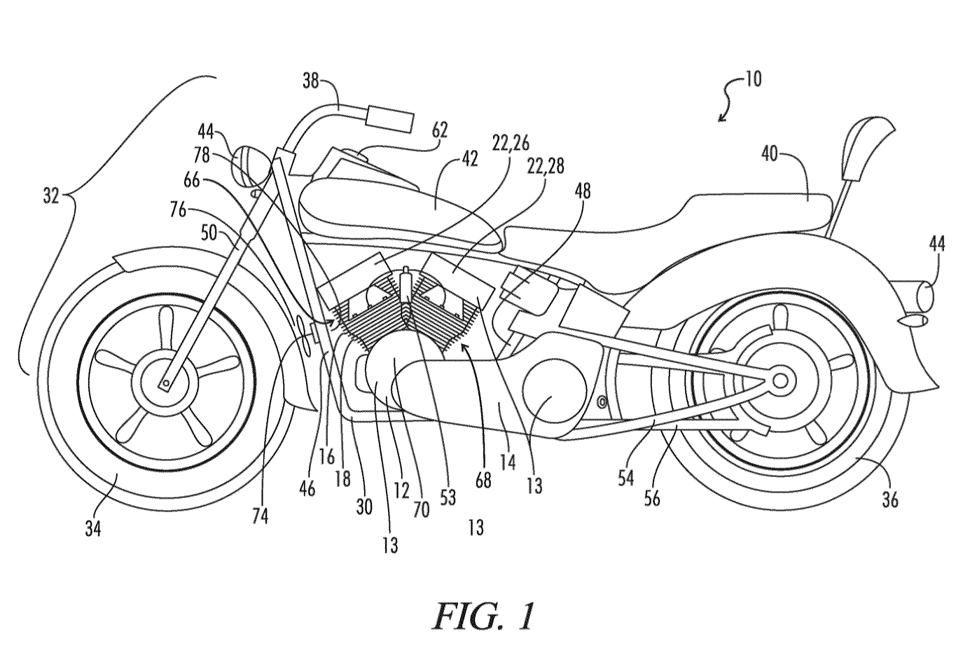

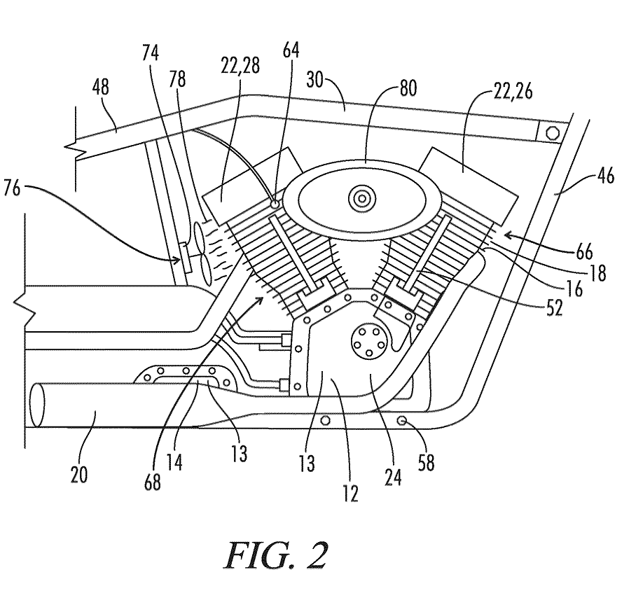

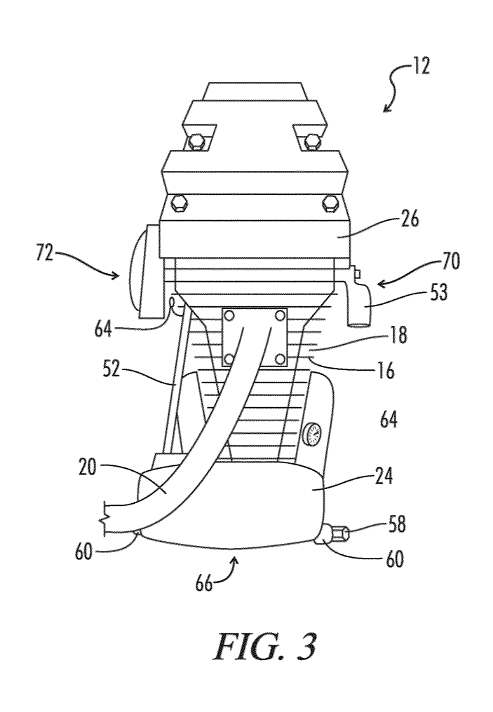

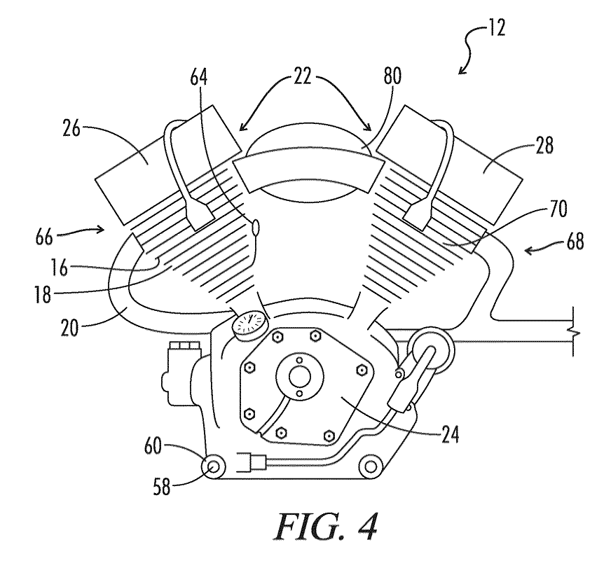

A motorcycle 10 can have many components, as shown in FIGS. 1 through 4. The motorcycle 10 has a drive train 13, where the drive train includes an air cooled engine 12 and a connected transmission 14. The primary means of cooling the air cooled engine 12 is convection, where heat is transferred to the air flowing around the engine 12, and the heated air flows away from the engine 12.

To increase heat transfer rates, many engines 12 use fins 16 to create more surface area for the air to contact the engine 12. There is a channel 18 between adjacent fins 16, and air can flow through the channel 18. The fins 16 are designed to improve cooling from air flow. In one embodiment, fins 16 are positioned such that the channel 18 is approximately parallel to the nature air flow past the engine 12 as the motorcycle 10 is ridden. This means the fins 16 are approximately horizontal, or at least close enough to horizontal that a significant portion of the normal air flow from riding the motorcycle 10 will contact and flow through the channels 18. Fins 16 are often used on engine cylinders, because cooling the cylinders is very effective for controlling engine temperature.

The cylinders 22 produce heat when in operation, and transfer heat to the air near the cylinders 22. Hot air expands, so there is a natural flow of hot air away from the cylinders 22. The hot air flowing away from a cylinder 22 tends to shield the cylinder from air flow directed straight in towards the cylinder 22, where air flow straight towards the cylinder 22 is air flow perpendicular to the channels 18. Air flow directed through the channels 18 tends to be more effective for cooling than air flow directed perpendicular to the channels 18. Air flow running parallel to the channels 18 tends to pass through the channels 18 and supplements the natural flow of hot air away from the cylinder 22. Air flow directed straight towards the cylinder 22 is resisted by the natural hot air flow away from a cylinder 22. Aerodynamically establishing air flow to pass around a cylinder 22 and flow through the channels 18 provides better engine cooling than air flow directed straight towards a cylinder 22.

Several other factors can affect the cooling of air cooled engines 12. For example, some motorcycle manufacturers have designed their engines 12 to run on a leaner mixture of fuel, which means there is less fuel mixed with the air which is fed into the engine 12. This leaner mixture of fuel can cause higher operating temperatures for the engine 12. It may be that the fuel itself cools the engine 12, and the leaner mixture provides less fuel for cooling. Other factors that affect cooling include cylinder placement, oil capacity and flow patterns, fin placement, and exhaust pipe placement.

Heat is generally produced within an engine 12 from two primary sources. One heat source is fuel combustion, which is an exothermic reaction producing heat. A second heat source is friction from the movement of the various parts within the engine 12. The higher the temperature of an engine 12 at a given air temperature and air flow rate, the higher the rate of heat transfer from the engine 12 to the air. Heat transfer from the engine 12 to the air is the primary source of cooling for the engine 12. For an engine 12 to operate at a constant temperature, the rate of heat generation has to equal the rate of heat dissipation or cooling.

When engines 12 are run cooler, they tend to have a longer life. Higher temperatures can degrade the oil, which increases the viscosity of the oil. Higher temperatures also cause the metal to expand, so tolerances tend to become smaller at the same time as the engine oil become more viscous. The smaller tolerances with more viscous oil can result in metal scrapping, scratching, and/or galling other engine components. Higher temperatures can decrease the useful life of an engine, and overheating can result in engine failure.

### The Motorcycle

A motorcycle 10 has many components. This includes the frame 30 which has a front portion 46 and a rear portion 48. The steering assembly 32 is pivotally connected to the frame front portion 46, and the steering assembly 32 includes the handlebars 38, the front wheel 34, the front forks 50 which can include shock absorbers, front lights 44 and may include other things such as instruments and a fairing upper. The rear wheel 36 is connected to the frame rear portion 48, and this connection can be made with a swing arm 54. In some embodiments, the motorcycle 10 can include two rear wheels 36, and such motorcycles 10 are frequently referred to as “trikes.” The swing arm 54 can be designed to allow travel such that the rear wheel 36 can absorb shocks for the rider. There can be shock absorbers or other devices utilized with the swing arm 54 and the rear wheel 36 to support the motorcycle 10 and absorb shocks for the rider.

The engine 12 and transmission 14 are connected and form the power train 13. The air cooled engine 12 powers the transmission 14, and the transmission 14 powers the rear wheel 36. A chain or belt is typically used to transfer power from the transmission 14 to the rear wheel 36. There can be a belt cover 56 over the chain or belt to keep people's fingers and toes from becoming entangled in the belt during operation. The drive train 13 is typically connected to the frame 30 using motor mounts 58. These motor mounts 58 can include a resilient material 60 to absorb some of the vibrations from the engine 12, which reduces the vibrations felt by the rider.

The motorcycle 10 can include several other components, including the seat 40. There can be saddlebags and/or a trunk for storage (not shown.) There can be lights 44 which can be mounted on both the front and back of the motorcycle 10 as well as along the side or underneath. There can be an electrical system which includes a battery. There can be a speedometer 62 which can be tied to a computer to help control the operations of the motorcycle 10. There can also be fairings, windshields and other attachments used for aerodynamics, comfort, and/or decoration. The motorcycle 10 can also include other devices such as a thermostat 64 positioned near the engine 12, such as adjacent to a cylinder 22. The thermostat 64 measures the temperature near the engine 12 and can be used to control various components based on engine temperature.

### Motorcycle Appearance

For many manufacturers, the appearance of a motorcycle 10 is very important. The appearance of a motorcycle 10 is important to the image the motorcycle 10 gives to the rider. The public may have come to recognize the appearance of a particular brand of motorcycle 10, and consumers may have developed an affinity for that motorcycle 10. Often times, the sales of a brand of motorcycle 10 can be largely influenced by the appearance of that motorcycle 10. The motorcycle engine 12 is an important component of the overall motorcycle appearance. The motorcycle engine 12 may be presented with an open design, such that the engine 12 is largely visible from the side when viewing the motorcycle 10. If a portion of the rider's body blocks the view of an engine 12, it does not change the open design; the open design is based on visibility of the engine 12 with no rider on the motorcycle 10.

Some motorcycle manufacturers use fairing, cowling, or other techniques to at least partially cover an engine 12. The fairing can be used for aerodynamic air flow purposes, and it can also be used to guide air flow around and past an engine 12 for cooling. The fairing can guide air flow to and from the air intake for the combustion process, and can be used with or without a fan for air movement. Fairing can produce an engine 12 with a closed appearance, where significant portions of the engine 12 are not visible from a side view of the motorcycle 10 because the fairing is in the way.

The engine 12 can have several components. For example, the engine 12 can include exhaust pipes 20, cylinders 22 and a crank case 24. One type of engine 12 is referred to as a V-twin engine 12. A V-twin engine 12 has two cylinders 22, including a front cylinder 26 positioned in front of a back cylinder 28. The engine fins 16 can be positioned primarily, or in some embodiments exclusively, on the cylinders 22. In some embodiments, the front cylinder 26 is positioned directly in front of the back cylinder 28, and the engine 12 is said to have an “in line” design. In other embodiments, the back cylinder 28 can be positioned at least somewhat to one side of the front cylinder 26, and the engine 12 is said to have an “offset” design. If the front and back cylinders 26, 28 are offset, the back cylinder 28 can receive some air flow which has not flowed past the front cylinder 26. The angle between the front and back cylinder 26, 28 in V-twin engines 12 can vary, where different manufactures provide V-twin engines angles including 42, 45, 47, 52, 60, 75, 80 and 90 degrees.

Some motorcycle components can be changed or customized more easily than others. For example, a motorcycle 10 can be painted in different colors, different types of handlebars 38 can be used, different seats 40 or fuel tanks 42 can be used, different exhaust pipes 20 and different configurations of lights 44 can be employed. However, some components of a the design of the engine 12 of a motorcycle 10. It can also be difficult for an end user to modify a frame 30, although it is easier to modify a frame 30 than an engine 12. Because the engine 12 is difficult to modify, the appearance of the engine 12 serves to identify the manufacturer of the motorcycle 10. Consumers tend to recognize engines 12, and this identification serves to develop public good will and recognition for the manufacturer. Therefore, even though many parts of a motorcycle 10 may be changed markedly between different users, the engine 12 is one component which tends to remain fixed and recognizable despite varying paint schemes, handlebar setups 38, seat configurations 40, fuel tanks 42 and various other attachments.

### Exposed Engine Sides

The engine 12 can be viewed from various angles. The engine 12 has a front end 66 and rear end 68. The engine 12 also includes a left side 70 and a right side 72. The engine 12 can be substantially exposed from the side, meaning that an individual standing directly beside the motorcycle 10 would be able to see most of the engine 12. The engine 12 is defined as being substantially exposed if at least 80% of the left or right side 70, 72 of the engine is visible from the side. There can be fairings, including fairing lowers, on the motorcycle 10 and the engine 12 can still be substantially exposed if at least 80% of the left or right side 70, 72 of the engine is visible. When the engine 12 is substantially exposed, the engine sides 70, 72 are exposed to air flow which can affect cooling of the engine 12. Different effects, considerations, and designs are used for cooling motorcycle engines 12 with fairings or other covers, as opposed to substantially exposed engines 12.

A motorcycle 10 typically has two wheels, as opposed to four wheels for many other vehicles. Three wheeled vehicles are included in the definition of a motorcycle 10 for this description. The body of a two wheeled vehicle is limited in size, so there is less space for additional components than in most four wheeled vehicles. There are more opportunities for providing duct work, fans, water cooling systems, space for air flow, and other components on a four wheeled vehicle than on a motorcycle 10 because of the amount of space available. A four wheeled vehicle is also more stable than a motorcycle 10; cars don't typically fall over. The nature of a motorcycle 10 has some inherent differences from a four wheeled vehicle, so the implementation and design of various components tends to be different.

### Blower

A blower 74 is connected to the motorcycle 10 to aid in cooling the engine 12. The blower 74 can have different embodiments, such as a simple fan which spins about an axis. The fan has blades which catch the air and create a high pressure side of the fan and a low pressure side of the fan. The blower 74 can also be rotating fins located within a housing that centrifugally thrusts air outward. The blower 74 should be constructed to withstand the temperatures it will be exposed to from the motorcycle engine 12 and from the environment. The blower 74 also should be constructed to withstand exposure to water from the environment, and to withstand shocks and vibrations from driving. The blower 74 can be any device which is used for creating air flow by producing a low pressure air inlet 76 and a higher pressure air discharge 78. If the blower 74 is a simple fan, the air inlet 76 can be as simple as the low pressure side of the fan blades when the fan is rotating and the air discharge 78 can be as simple as the high pressure side of the fan blades where the air is moving away from the fan. The blower 74 can be powered by an electric motor connected to the battery or the electrical system of the motorcycle 10.

The blower 74 is isolated from engine vibration, at least to some extent. This isolation is the result of the use of resilient material 60 located between the engine 12 and the blower 74. Despite the use of resilient material 60, the blower 74 can be exposed to some vibration from the operation of the engine 12. In one embodiment the resilient material 60 is positioned in the motor mounts 58. It is also possible to use the resilient materials 60 at other locations, such as in a mount or bracket used to connect the blower 74 to the motorcycle 10. The resilient material 60 can be rubber, silicone, certain polymers, or any of a wide variety of materials. The resilient material 60 should be positioned between the blower 74 and the drive train 13 to reduce engine vibrations at the blower 74.

In one embodiment, the blower 74 is mounted on the frame 30 and positioned such that the air discharge 78 is directed towards a cylinder 22. The blower 74 can be mounted in front of the front end 66 or behind the rear end 68 of the engine 12. In either case, the blower 74 is mounted with the air discharge 78 directed towards an end 66, 68 of the engine 12. It is also possible to mount the blower 74 in other locations and direct the air discharge 78 to an end 66, 68 of the engine 12 with ducts or other similar devices. The blower 74 can be mounted to motorcycle components other than the frame 30 as well. For example, the blower 74 could be mounted to the bottom of the seat 40, with the air discharge 78 directed at one end 66, 68 of the engine 12. In some embodiments, modifications of the motorcycle 10 may be necessary to accommodate the blower 74.

In one embodiment, the blower 74 is relatively discreet such that it is not clearly visible from a side surface. Some may prefer the blower 74 is not clearly visible on the motorcycle 10. This can be accomplished by positioning the blower 74 in locations concealed by other components of the motorcycle 10, and/or by using coloration to match various components of the motorcycle 10. Painting the blower 74 black and positioning it in a shaded area with other black parts and components may make the blower 74 discrete, and hard to see.

The blower 74 provides the greatest benefit when the motorcycle 10 is operating at slow speeds. This is because operation of the motorcycle 10 at slow speeds produces the conditions most likely to result in engine 12 overheating. The blower 74 can be actuated by the thermostat 64 such that the blower 74 will begin operating and directing air towards the engine 12 when the thermostat registers above a first set point, and the blower 74 will stop operating when the thermostat 64 registers a temperature lower than a second set point. Typically, the first set point would be higher than the second set point to reduce unnecessary cycling of the blower 74, which means to reduce turning the blower 74 on and off repeatedly and unnecessarily. Operating a motorcycle 10 with a cooler engine 12 is more comfortable for the rider, because excess heat from the engine 12 is reduced.

In another embodiment the blower 74 can be actuated by the speedometer 62. In this embodiment, if the speed of the motorcycle 10 were to fall below a predetermined speed the blower 74 would be actuated and begin operating. This would provide for the blower 74 cooling the engine 12 when the motorcycle 10 was traveling at slow speeds or stopped. It is also possible to use a combination of the thermostat 64 and the speedometer 62 for actuating the blower 74, as well as other monitoring devices which can be used to indicate when the blower 74 should be operated. In an alternative embodiment, the motorcycle 10 can include a manual control switch for engaging and/or disengaging the blower 74. The manual control switch could be used alone or in combination with other devices to control the blower 74.

### Blower Air Flow

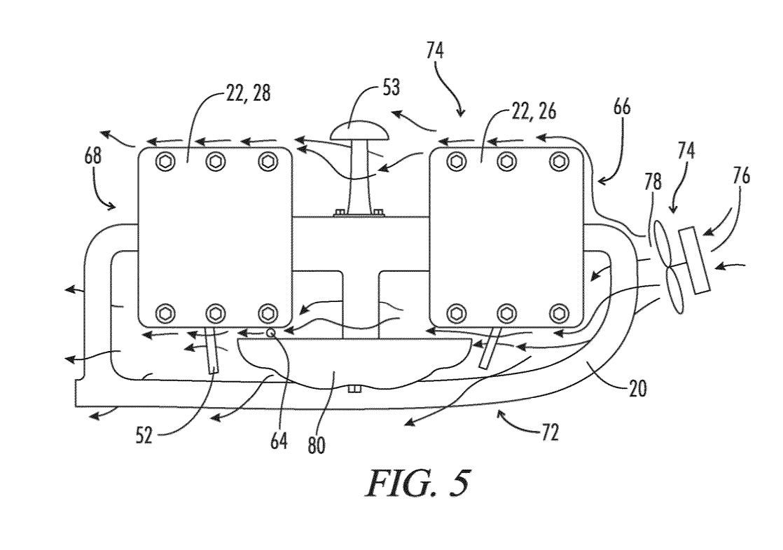

The blower 74 directs air from the air discharge 78 for cooling the engine 12. Proper placement of the blower 74 and the air discharge 78 can improve the efficiency of engine cooling, as seen by referring to FIG. 5, with continuing reference to FIGS. 1-4. Arrows show the air flow in FIG. 5 where only the cylinders 22 and other components above the crank case 24 are shown. Preferably, air moving around the engine 12 should move around the entire cylinder 22 to provide the best cooling for the engine 12. The more surfaces of the cylinder 22 which are exposed to air flow, the better the cooling. If the blower 74 directs air towards only one portion of a cylinder 22, it will tend to produce less cooling than a blower 74 pushing the same quantity of air where the air flows around more surface area of the cylinder 22.

The air discharge 78 should preferably be directed such that air flows through the channels 18 between the fins 16. Air flow through the channels 18 utilizes the extra surface area provided by the fins 16 more effectively. Air flow through the channels 18 also provides better cooling than air flow directed straight at the surface of a cylinder 22, because the air flow through the channels 18 supplements the natural air flow created by hot air expanding and moving away from the cylinder 22. The air discharge 78 does not have to be directed exactly parallel with the channels 18, as long as the air discharge 78 is angled such that a portion of the air flow passes between the fins 16. Positioning the blower 74 near an end 66, 68 of the engine can cause air flow around the left and right sides 70, 72 of the engine 12. The air flow around the left and right engine sides 70, 72 is parallel to the channels 18. Air flow wrapping around an end 66, 68 of the engine 12 can include locations where the air flow is parallel to the channels 18.

A blower 74 directing air flow away from an engine 12 can cause significant air flow IF cowlings, fairings, or other flow control devices are used to direct the air flow. When a motorcycle 10 has a substantially exposed engine side surface 70, 72, the air discharge 78 should be directed towards the engine 12 to produce a higher air flow around the surfaces of the engine 12. An air discharge 78 directed away from an engine does not produce as much air flow through the channels 18 as an air discharge 78 directed towards the engine 12, especially for an engine 12 with a substantially exposed engine side surface 70, 72. Many radiators used for cooling liquid coolants will face the air discharge 78 away from the radiator, and draw air through the radiator. Shrouds, cowlings, cases, or other such devices are usually used when drawing air past an object for cooling. To maintain the open appearance of a motorcycle 10, the use of shrouds, cowlings, ducts, or other such devices should be minimized. An open appearance can be important for motorcycle sales, so directing the air discharge 78 towards the engine 12 instead of away from the engine 12 can be important.

The size and flow rate of the blower 74 can impact the cooling effect. If air flow from the blower 74 is at too high a velocity, the air flow will tend to “bounce” off the first surface contacted, and there may not be air flow wrapping around the sides of the cylinders 22 and through the channels 18. However, as explained earlier, a higher air flow tends to produce greater cooling. Also, an air discharge 78 with a small area will not have as much of a tendency to wrap around the sides of the cylinders 22 as an air discharge 78 with a larger area. By adjusting the flow rate and area of the air discharge 78, one can design a blower 74 with air flow impacting the front or rear end 66, 68 of one cylinder 22 of the engine 12 and wrapping around and flowing along the left and right sides 70, 72 of both cylinders 26, 28 simultaneously.

When using a V-twin engine 12, the front cylinder 26 tends to run cooler than the back cylinder 28, especially for “in line” designs. This is because air flow generally begins from the frame front portion 46 and proceeds towards the rear as the motorcycle 10 moves through the air. The air impacting the front cylinder 26 is warmed, and this same warmed air then reaches the back cylinder 28. Warmer air does not cool an engine 12 as well as cooler air, and the back cylinder 28 has warmer air flowing around it than the front cylinder 26 when the motorcycle 10 is moving. Also, the front cylinder 26 serves as a wind break and reduces the air flow reaching the back cylinder 28. Because of the decreased air flow and the warmer air flow temperature, the back cylinder 28 tends to run hotter than the front cylinder 26.

By positioning the blower 74 and the air discharge 78 on one end 66, 68 of the engine 12, the blower 74 can move air past significant surface area on the engine 12. The discharged air strikes the end surface of the cylinder 22 and then passes around both the cylinder left side 70 and the cylinder right side 72. This blower positioning allows for air flow contact on multiple sides of the cylinder 22, and through the channels 18. This positioning also allows for the air flow to pass both the front and back cylinder 26, 28, because the air flow is generally in line with the engine cylinders 22. It has been discovered that mounting the blower 74 facing either the front or rear ends 66, 68 of the engine 12 can result in air flow on both the left and right sides 70, 72 of both cylinders 26, 28. This positioning of the blower 74 allows for cooling of the engine 12 and allows for greater operation times of the motorcycle 10 under conditions that tend to cause overheating of the engine 12.

In one embodiment, the blower 74 is angled such that the air discharge 78 is directed to simultaneously cause air flow on both the left and right sides 70, 72 of the engine 12. The blower 74 also produced air flow on at least one end 66, 68 of the engine 12, and in some embodiments on air flow wraps around both ends 66, 68 of the engine 12. On many motorcycle engines 12 there are obstacles for the air flow. These obstacles can include things like exhaust pipes 20, lifter rods 52, and air filters 80. These obstacles tend to restrict and slow air flow. To compensate for these obstacles, the air discharge 78 can be directed such that a greater portion of the air flow is directed towards the side of the engine 12 which is more restricted. In FIG. 5, with continuing reference to FIGS. 1-4, the blower 74 is positioned slightly to the engine right side 72 and the blower 74 is also angled slightly to the engine right side 72. This blower positioning is used to overcome the extra obstacles on the engine right side 72.

In one embodiment, the exhaust pipe 20, the lifter rod 52 and the air filter 80 are all positioned on the engine right side 72. A horn 53 is positioned on the engine left side 70, so there are more obstacles and greater resistance to flow on the engine right side 72. In this example, the air discharge 78 could be positioned closer to the engine right side 72 and directed straight at the engine 12. Alternatively, the air discharge 78 could be angled such that the air discharge 78 was not perpendicular to the engine front end 66, but was at an angle directing more of the air flow towards the engine right side 72. Combinations of moving the blower 74 position further to the more obstructed side of an engine 12 or angling the blower to cause more air flow on the more obstructed side of the engine 12 could be used.

When mounting a blower 74, consideration must be given to the normal moving parts of the motorcycle 10. For example, the motorcycle forks 50 can contain shock absorbers causing the front wheel 34 to travel up and down. A blower 74 mounted on the frame 30 between the frame 30 and the forks 50 could be contacted and damaged by the front wheel 34 as the front wheel 34 travels up and down. This sort of mechanical movement must be accounted for when the blower 74 is positioned.

### Rear Mounted Blower

In one embodiment, the blower 74 is mounted such that the air discharge 78 is directed towards the engine rear end 68. In particular, the air discharge 78 can be directed towards the rear end 68 of the back cylinder 28. The blower 74 can be positioned behind the engine 12, and the blower 74 can be mounted to the frame 30. In this embodiment, the air flow from the blower 74 runs counter to the air flow from the motorcycle motion when the motorcycle 10 is moving forward. The blower 74 can be positioned approximately parallel to the fins 16 such that air flows through the channel 18 between the fins 16, or the blower 74 can be set such that a significant portion of the air flow enters the channels 18, such as positioning the air discharge 78 at an angle of 45 degrees or less from the fins 16. In this embodiment, air flow is directed towards and directly impacts the back cylinder 28. As discussed previously, the back cylinder 28 tends to run hotter than the front cylinder 26, so this embodiment allows for maximum cooling of what tends to be the hottest part of the engine 12.

Positioning the air discharge 78 behind the engine 12 provides cooling for the front cylinder 26 as well as the back cylinder 28. Some air from the air discharge 78 flows along the left and right side surfaces 70, 72 of the front cylinder 26 after passing around the back cylinder 28. Therefore, the front cylinder 26 is also cooled by directing the air discharge 78 towards the rear end 68 of the engine 12. The air discharge 78 is directed towards the rear end 68, so there has to be sufficient room in the design of the motorcycle 10 to allow this positioning. The blower 74 can be positioned behind the back cylinder 28 for simplicity, but the blower 74 can be positioned in other locations with the air discharge 78 directed to the rear end 68 of the engine 12, such as with ducts.

It is possible for the air flow from the blower 74 to be countered by the motion of the motorcycle 10 when the motorcycle 10 is traveling at relatively slow speeds. In this case, the forward air flow from the blower 74 impacts the rearward air flow from the motorcycle 10 motion, and the heated air tends to “mushroom” out onto the legs of the rider and/or the passenger. This can be countered by providing a switch to disengage the blower 74 when certain conditions are met. The switch can be based on a sensor detecting air motion from the blower 74, or the switch can be based on the speedometer 62. A speedometer switch could activate at known speeds which tend to cause hot air flow onto the rider's and/or passenger's legs. Any operations based on the speedometer 62 may be controlled or operated through an on-board computer, data processor, or similar device.

Positioning the blower 74 behind the engine 12 has some additional benefits. The transmission 14 of many motorcycles 10 is positioned largely behind the engine 12, so the transmission 14 may be cooled somewhat by increased air flow behind the engine 12. Also, the space behind the engine 12 tends to be relatively protected from air flow, so a blower 74 in this location provides air flow to a sheltered area. The back cylinder 28 tends to be the hottest, and an air discharge 78 behind the engine 12 tends to cool the back cylinder 28. A cooler back cylinder 28 can improve rider comfort by reducing heat transferred from the engine 12 to the rider.

### Front Mounted Blower

In an alternative embodiment, the blower 74 is mounted such that the air discharge 78 is directed towards the engine front end 66. In this case the blower 74 can be mounted to the frame 30 forward of the engine 12, or the blower 74 can be mounted elsewhere with ducts to direct the air discharge 78 to the engine front end 66. This embodiment allows for the air flow from the blower 74 to be supplemented by any air flow caused by the motorcycle 10 moving forward. Therefore, this positioning of the air discharge 78 tends to increase any natural cooling caused by motion of the motorcycle 10. The air flow from the blower 74 is directed towards the front cylinder 26, so the front cylinder 26 receives a greater cooling effect than the back cylinder 28 in this embodiment. Similar to the embodiment with the air discharge 78 directed towards the rear end 68, air flow in this embodiment can reach the back cylinder 28 after passing around the front cylinder 26. Therefore, the back cylinder 28 is cooled, but the front cylinder 26 receives more cooling. The air discharge 78 is positioned such that there will be air flow through the channels 18 between the fins 16 of the cylinders 22.

### Top Mounted Blower

An alternative embodiment includes positioning the blower 74 and the air discharge 78 above the engine 12. In some instances, the fuel tank 42 can be modified to produce a pocket for the blower 74, but some additional modification may be necessary to accommodate a blower 74. This allows for very discreet positioning of the blower 74, but it can also result in some decreased capacity within the fuel tank 42. The air discharge 78 can be directed downward onto the cylinders 22, and it can be directed in such a way as to cause air flow between the front and back cylinder 26, 28. It should be mentioned that certain motorcycles 10 have fairings which affect air flow around the motorcycle 10 and/or the rider. The blower 74 will function to cool the engine 12 with or without fairings. The use of fairings can change air flow around a motorcycle 10, but the blower 74 maintains its function. Part of the reason for the blower 74 maintaining its function is because the blower 74 is most effective when the motorcycle 10 is either stopped or at very slow motion, so any induced air flow from the motorcycle motion is relatively small.

### Example

The effectiveness of the current invention can be shown with an example. A motorcycle 10 associated with the trademark HARLEY DAVIDSON, a 2007 model Screamin' Eagle Ultra Classic was outfitted with a blower 74 having an air discharge 78 directed toward the front end 66 of the engine 12. The blower 74 was a fan with an electric motor, and was mounted to the frame 30 between the frame 30 and the front wheel 34. The fan operated on 12 volts, drew between 1.5 and 2 amps, had six blades and a diameter of approximately 5.5 Inches. Temperatures were measured using an infrared thermometer directed at the channels 18 of the cylinders 22 on the engine right side 72.

The motorcycle 10 was driven approximately 4 hours and then parked with the engine 12 idling, and temperature measurements were started when the blower 74 was turned on after parking the motorcycle 10. The outside temperature was 88 degrees. All temperatures are in degrees Fahrenheit, and the results are listed in the Table 1 below.

TABLE 1

| motorcycle parked, | | | | |
|---|---|---|---|---|
| blower initiated | 0 minutes | 5 minutes | 10 minutes | 15 minutes |
| Front cylinder temp | 277 | 272 | 253 | 244 |
| Back cylinder temp | 318 | 314 | 298 | 290 |

For the sake of comparison, a hypothetical example is presented below in Table 2 for a similar motorcycle 10 under similar conditions, except with no blower 74. The example presented below is hypothetical.

TABLE 2

| Hypothetical | | | | |
|---|---|---|---|---|
| example, | | | | |
| motorcycle parked, | | | | |
| no blower | 0 minutes | 5 minutes | 10 minutes | 15 minutes |
| Front cylinder temp | 277 | 290 | 315 | 325 |
| Back cylinder temp | 318 | 320 | 330 | 340 |

In the hypothetical example, the motorcycle may begin a pre-ignition sequence due to engine overheating at approximately 15 minutes after being parked. The hypothetical example with no blower 74 shows the engine temperature increasing with time, as compared to the actual example with a blower 74 where the engine temperature decreases with time.

As shown in Table I in the actual example with a blower 74, the temperature at the surface of the cylinders 22 was reduced within at least five minutes of initiating the blower 74. In this actual example, a fan was used for the blower 74, the air discharge 78 was positioned in front of the front cylinder 26 and directed towards the engine front end 66, and the blower 74 cooled both the front the back cylinders 26, 28.

While the invention has been described with respect to a limited number of embodiments, those skilled in the art, having the benefit of this disclosure, will appreciate that other embodiments can be devised which do not depart from the scope of the invention as disclosed here. Accordingly, the scope of the invention should be limited only by the attached claims.

I claim:

1. A motorcycle comprising:
a frame having a front portion and a rear portion;
a steering assembly pivotably connected to the frame front portion, the steering assembly including a rotatable front wheel;
a rear wheel rotatably connected to the frame rear portion;
a drive train connected to the frame, the drive train including an air cooled engine and a transmission, where the engine and transmission are connected together such that the engine powers the transmission, where the transmission powers the rear wheel, where the engine is a V-twin engine having a front cylinder positioned directly in front of a back cylinder, the engine having two sides including a left side and a right side, and two ends, including a front end and a back end, where the engine sides are substantially exposed, and where the engine cylinders include fins;
motor mounts connecting the drive train to the frame, where the motor mounts include a resilient material for dampening vibrations;
a thermostat positioned within the engine; and
a blower connected to the frame, where the blower includes an air discharge directed towards at least one end of the engine, where the air discharge is angled to produce air flow between engine fins, where the air discharge is angled to simultaneously produce air flow around the left and right sides of the engine, and where the blower is actuated by the thermostat.

2. The motorcycle of claim 1 where the air discharge is directed towards the engine front end.

3. The motorcycle of claim 1 where the air discharge is directed towards the engine rear end.

4. A motorcycle comprising:
a frame including a front portion and a rear portion;
a drive train connected to the frame, the drive train including an air cooled engine connected to a transmission, where the engine comprises a V-twin engine having a front cylinder positioned in front of a back cylinder, where the engine includes a front end, a rear end, a left side, and a right side, and where the engine sides are substantially exposed;
a blower connected to the motorcycle, the blower having an air discharge directed toward one end of the engine.

5. The motorcycle of claim 4 further comprising a resilient material positioned between the drive train and the blower.

6. The motorcycle of claim 5 further comprising a motor mount, where the resilient material is included in the motor mount.

7. The motorcycle of claim 4 where the air discharge is angled to simultaneously produce air flow on the left side and the right side of the engine.

8. The motorcycle of claim 4 where the air discharge is directed toward the front end of the engine.

9. The motorcycle of claim 4 where the air discharge is directed toward the rear end of the engine.

10. The motorcycle of claim 4 further comprising a thermostat positioned within the engine, where the blower is actuated by the thermostat.

11. The motorcycle of claim 4 further comprising a speedometer, where the blower is actuated by the speedometer.

12. The motorcycle of claim 4 where the cylinders include fins, and the air discharge is angled to provide air flow between the fins.

13. A motorcycle comprising:
a frame including a front portion and a rear portion;
a steering assembly pivotably connected to the frame front portion, the steering assembly including a rotatable front wheel;
a rear wheel rotatably connected to the frame rear portion;
a drive train including an air cooled engine connected to a transmission, where the engine comprises a V-twin engine with a front cylinder positioned directly in front of a rear cylinder, where the engine includes a front end, a rear end, a left side, and a right side, the engine sides are substantially exposed, and the transmission interconnects with and powers the rear wheel;
a motor mount connecting the drive train to the frame; and
a blower having an air discharge, the blower mounted to the frame with the air discharge directed toward one end of the engine, and where the air discharge is angled to produce air flow on the left side and right side of the engine at the same time.

14. The motorcycle of claim 13 further comprising a resilient material positioned between the drive train and the blower.

15. The motorcycle of claim 14 where the resilient material is included in the motor mount.

16. The motorcycle of claim 13 where the air discharge is directed toward the front end of the engine.

17. The motorcycle of claim 13 where the air discharge is directed toward the rear end of the engine.

18. The motorcycle of claim 13 further comprising a thermostat positioned within the engine, where the blower is actuated by the thermostat.

19. The motorcycle of claim 13 where the cylinders include fins, and the air discharge is angled to provide air flow between the fins.

20. A motorcycle comprising:
a frame including a front portion and a rear portion;
a drive train including an air cooled engine connected to a transmission, where the engine includes a front end, a rear end, a left side, and a right side, and the engine sides are substantially exposed;
a motor mount connecting the drive train to the frame; and
a blower having an air discharge, the blower connected to the motorcycle with the air discharge directed toward one end of the engine, and where the air discharge is angled to simultaneously produce air flow on the left side and right side of the engine.
